(19) United States
(12) Patent Application Publication
(10) Pub. No.: US 2019/0246148 A1
(43) Pub. Date: Aug. 8, 2019

(54) METHOD AND SYSTEM FOR SCRAMBLING BROADCAST WITH LOW LATENCY

(71) Applicant: DIGICAP CO., LTD., Seoul (KR)

(72) Inventors: Sungheun OH, Seoul (KR); Kitaek LEE, Goyang-si (KR); Kyeongjin PARK, Seoul (KR)

(73) Assignee: DIGICAP CO., LTD., Seoul (KR)

(21) Appl. No.: 15/888,740

(22) Filed: Feb. 5, 2018

(51) Int. Cl. H04N 21/2347; H04L 9/06; H04L 9/08; G06F 21/10; H04N 21/643

(52) U.S. Cl. CPC H04N 21/2347; H04L 9/0631; H04L 9/0861; G06F 2221/0724; G06F 21/10; H04N 21/643; H04L 9/0819

(57) ABSTRACT

A broadcast scrambling system with low latency may transmit an encrypted broadcast file with low latency through a method performed by the broadcast scrambling system, the method including determining an encryption application policy before a broadcast file is input through an input interface; pre-modifying information included in a header box of the broadcast file to be changed when media data is encrypted according to the encryption application policy and immediately transmitting the header box to which an encryption application parameter is added; and encrypting the media data on an encryption block unit basis and immediately transmitting the encrypted media data on a block unit basis.

### BACKGROUND

### 1. Field

The present invention relates to a file-based broadcast scrambling method, and particularly, to a method in which a broadcast scrambling system pre-modifies a header box to information to be changed by encryption before reception of media data, immediately transmits the information, encrypts the media data on an encryption block basis, and immediately transmits the media data to reduce time delay caused by scrambling.

### 2. Discussion of Related Art

Generally, in a pay TV broadcast service environment, a pay TV broadcast provider allows only qualified viewers to watch broadcast content by scrambling the broadcast content by means of encryption, broadcasting the broadcast content, and providing a decryption key to only qualified receivers in order to prevent illegal access to the broadcast service.

Broadcast content is transmitted via various protocols based on various packets such as MPEG-2 Transport Stream (TS) packets or User Datagram Protocol (UDP)-based Real Time Protocol (RTP) packets. For MPEG-2 TS packets, scrambling is performed in units of single TS packets. A packet header may not be encrypted, and only a payload part may be encrypted. Whether to encrypt a payload is marked by using a transport scrambling control bit of a TS packet header. Likewise, scrambling an RTP packet is performed in units of single RTP packets. An RTP header may not be encrypted, and only an RTP payload part may be encrypted.

Recently, broadcasting system environments have adopted a broadcast content transmission scheme using a file-based protocol in addition to a broadcast content transmission scheme using a packet-based protocol. For example, a segment-based streaming protocol such as HTTP Live Streaming (HLS) and MPEG Dynamic Adaptive Streaming over HTTP (DASH) supports not only packet transmission but also file transmission.

MPEG DASH technology supports transmission of ISO base Media File Format (ISOBMFF) files in addition to transmission of files composed of MPEG-2 TS packets. File-segment-based MPEG DASH technology has been mainly used to provide VoD service and real-time TV streaming service in an interactive broadcast environment. However, recently, a new transmission scheme substituted for the conventional MPEG-2 TS packet transmission scheme is being expansively used in a unidirectional broadcast environment (terrestrial broadcasting, etc.).

An ISOBMFF segment file may be composed of one or more tracks (e.g., a video track, an audio track), and each of the tracks may be composed of one or more samples.

Accordingly, unlike an MPEG-2 TS packet or an RTP packet composed of a header and a media payload, a segment file has an object-oriented box structure in which a header box and a plurality of samples are mixed in one file. In order to encrypt a segment file having such a complicated structure, a broadcast scrambling system should identify and encrypt an object to be encrypted at a sample unit level of each track (e.g., a start position, a size, and the like of each sample), identify a header part associated with the encrypted sample, and add whether to encrypt the sample and also add used encryption key identification information.

As described above, a conventional broadcast scrambling system having an MPEG-2 TS packet or RTP packet composed of one header and one payload as an input unit may encrypt only one payload once. However, it is difficult to scramble a segment file having a complicated header and payload having a file structure including a plurality of objects to be encrypted (e.g., several samples).

Korean Patent Publication No. 1020170011251, entitled “FILE-BASED BROADCAST SCRAMBLING SYSTEM” proposes a system for encrypting an ISOBMFF broadcast file in order to solve such a problem.

Sequential encryption of media samples contained in mdat of an ISOBMFF file may increase the size of the media samples, so it may be necessary to modify size information of each sample in moof, which is a movie fragment box. Thus, it is possible to perform encryption, modify moof, and sequentially transmit moof and mdat while the entire broadcast file is received.

Accordingly, the broadcast scrambling system of the related art has a latency time due to such buffering, and the latency time is not suitable for real-time broadcasting.

### SUMMARY

The proposed invention is directed to providing a method of a file-based broadcast scrambling system capable of scrambling a broadcast file with very low latency.

According to an aspect, there is provided a method performed by a broadcast scrambling system, the method including determining an encryption application policy before a broadcast file is input through an input interface; pre-modifying information included in a header box of the broadcast file to be changed when media data is encrypted according to the encryption application policy and immediately transmitting the header box to which an encryption application parameter is added; and encrypting the media data on an encryption block unit basis and immediately transmitting the encrypted media data on a block unit basis.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram showing a procedure of a broadcast file scrambling method for low latency according to an embodiment;

FIG. 2 is a diagram showing a procedure of a broadcast file scrambling method for low latency according to another embodiment; and

FIG. 3 is a block diagram of a low-latency broadcast scrambling system according to an embodiment.

### DETAILED DESCRIPTION OF EXEMPLARY EMBODIMENTS

The above or other aspects will be implemented through embodiments described with reference to the accompanying drawings. It is to be understood that the components of each embodiment may be variously combined therein unless otherwise stated or mutually contradictory. In some cases, each block of a block diagram may represent a physical component. In other cases, each block may logically represent a partial function of a single physical component or a common function of a plurality of physical components. Sometimes, actually, a block or a part thereof may be a set of program instructions. All or some of the blocks may be implemented in hardware, software, or a combination thereof.

A broadcast file scrambling method according to an aspect includes determining an encryption application policy before a broadcast file to be encrypted is input; modifying information to be changed due to encryption corresponding to the encryption application policy among information included in a header box of the input broadcast file; and adding an encryption application parameter generated according to the encryption application policy to the header box and immediately transmitting the header box.

The encryption application policy is a method by which a broadcast scrambling system 100 encrypts a broadcast file. In order to minimize a transmission delay time due to encryption of a broadcast file, the broadcast scrambling system 100 predetermines information required for encryption before the broadcast file is received.

The broadcast scrambling system 100, which uses the broadcast file scrambling method according to an aspect, encrypts an ISO Base Media File Format (ISOBMFF)-type broadcast file. The ISOBMFF file is delivered through the User Datagram Protocol (UDP)/the Internet Protocol (IP), and particularly, in the case of an Advanced Television Systems Committee standard version 3.0 (ATSC 3.0) standard, through a Real-time Object delivery over Unidirectional Transport (ROUTE) protocol or an MPEG Media Transport (MMT) protocol.

While the MMT protocol is a standard that has been developed to compensate the disadvantages of MPEG-2 Transport Stream (MPEG-2 TS), which is the conventional broadcast transmission standard, the ROUTE protocol is a transmission standard improved to apply a transmission standard that has been used in the existing Internet network to a broadcast network.

The ISOBMFF file has a slightly different structure for each protocol. The ROUTE protocol has a Dynamic Adaptive Streaming over HTTP (DASH) segment structure, and the MMT protocol has a Media Processing Unit (MPU) structure.

In the ISOBMFF file, media samples are sequentially included in mdat, which is media data, and the total number of samples included in mdat (sample count), an offset value at which the first sample starts in mdat (data offset), the size of each sample (sample info size), and the like are included in moof, which is a header box.

A scheme of transmitting the ISOBMFF file over a network may include an in-order delivery scheme in which moof and mdat are sequentially delivered and an out-of-order delivery scheme in which mdat and moof are sequentially delivered.

The ISOBMFF file includes one or more media samples that may be played for one or two seconds, but depends on its settings. Thus, the broadcast scrambling system 100 should accurately find each sample in mdat in order to scramble each media sample. Accordingly, the broadcast scrambling system 100 uses the total number of samples included in moof, an offset value at which the first sample is started, and size information of each sample.

The encryption of the ISOBMFF file is performed on a media sample unit basis. A 3DES or AES algorithm, which is a symmetric-key-based block encryption algorithm, may be used as an encryption algorithm for encrypting each sample. An AES 128-bit encryption algorithm may be used as a block encryption algorithm according to an aspect of the present invention. In this case, when the size of an original sample and a mode to be used are predetermined, the size of an encrypted sample can be found out before actual encryption.

For example, in a Counter (CTR) mode, the size of the original sample is the same as the size of the encrypted sample. As another example, in a Cipher Block Chaining (CBC) mode, the encrypted sample has a maximally increased block size (128-bit block in the case of the AES 128 bit algorithm) relative to the size of the original sample. When the size of a sample increases due to encryption, the broadcast scrambling system 100 should encrypt the sample and modify size information (sample info size) of samples included in moof.

Also, the broadcast scrambling system 100 should add, to moof, an encryption algorithm (e.g., an AES 128-bit CTR mode) used to encrypt each sample, an encryption key identifier (Key ID) regarding with which encryption key the encryption is performed, whether each sample is encrypted, information regarding an initialization vector used during the encryption, and the like. The values may be predetermined before the encryption is performed.

An encryption application policy may be set by an operator through a graphical user interface (GUI) of the broadcast scrambling system 100 or may be set in cooperation with a specific database system. By predetermining the encryption application policy, the broadcast scrambling system 100 may modify moof even before encrypting a sample included in an ISOBMFF file received through the in-order delivery scheme.

Information that should be changed by the encryption according to the encryption application policy among information included in the header box of the input broadcast file includes size information after each sample included in mdat is encrypted.

When the ISOBMFF file is transmitted through the ROUTE protocol, the ISOBMFF file has a DASH segment structure. A segment is a small piece of encoded video data and includes two types of segments, that is, an initialization segment and a media segment. The initialization segment contains information necessary to decode a sequence of media segments containing actual video information and includes information such as codec initialization data, a track ID, a timestamp offset, etc. The media segment is actual video data including timestamp information on a media timeline to be played. The media segment may recognize a position at which the media segment is to be played on the basis of the initialization segment. When a received ISOBMFF file segment is the initialization segment, the broadcast scrambling system 100 extracts necessary information from the ISOBMFF file segment and stores and immediately transmits the extracted information. A received ISOBMFF file segment is a media segment that is transmitted immediately after the initialization segment is delivered. When a received ISOBMFF file segment is a segment transmitted in an in-order delivery scheme, moof is received before mdat is received. When moof is received, the broadcast scrambling system 100 modifies information that should be changed by encryption of each sample included in moof, that is, the size of each sample and the size of mdat into the size of the encrypted samples to be changed after the encryption and the size of mdat increased due to the encryption.

Subsequently, the broadcast scrambling system 100 adds an encryption application parameter generated according to the encryption application policy to a header box, i.e., to moof, and immediately transmits moof even before mdat is received.

The broadcast scrambling system 100 stores metadata of an original sample, an encryption application policy, and an encryption application parameter that are acquired from moof after moof is transmitted.

In the broadcast file scrambling method according to an aspect, the encryption application policy includes an encryption algorithm, an encryption key to be used to encrypt each sample, an encryption key identifier, an initialization vector, a criterion for selecting a sample to be encrypted, and encryption key change period information. The encryption application parameter includes an encryption algorithm identifier, an encryption key identifier, an initialization vector, and a list of samples to be encrypted. The metadata of the original sample includes the number of samples to be included in media data of a broadcast file to be input, a start offset of a first sample, and a size of each sample.

The encryption application policy may include an encryption algorithm, an encryption key, an encryption key identifier, an initialization vector, a criterion for selecting a sample to be encrypted, and encryption key change period information.

The encryption algorithm is an algorithm used to encrypt each sample, and a symmetric-key encryption algorithm with an encryption key and a decryption key the same as each other is used as the encryption algorithm. According to an aspect of the present invention, the Triple Data Encryption Standard (3DES), the Advanced Encryption Standard (AES), and the like may be used.

The encryption key, which is a symmetric key used to encrypt each sample, is also a key that is used during decryption. The encryption key identifier is an identifier for identifying an encryption key used for encryption.

The initialization vector (IV) is any binary data that is used to initialize the symmetric-key encryption algorithm. The initialization vector is used to encrypt identical plaintext into differing ciphertext whenever the encryption is performed. The encryption algorithm should be initialized by using the same initialization vector at the encryption side and the decryption side.

The criterion for selecting a sample to be encrypted is a criterion that determines whether to encrypt each sample. The broadcast scrambling system 100 may not encrypt all samples but may determine whether to encrypt each sample. Thus, there is a need for a criterion for selecting whether each sample is to be encrypted, and the criterion is included in the encryption application policy.

The encryption key change period information is information regarding a time period in which the encryption key is changed during encryption of a sample in a specific media track. The encryption key may be periodically changed during encryption according to the encryption key change period.

The encryption application parameter includes an encryption algorithm identifier, an encryption key identifier, an initialization vector, and a list of samples to be encrypted. The encryption application parameter is added to moof and used to deliver an encryption scheme of the broadcast scrambling system 100 to a broadcast receiver. The encryption application parameter is generated from the encryption application policy.

The encryption algorithm identifier is an identifier that is used for the encryption and that is mapped to the encryption algorithm, and the encryption key identifier is an identifier that is to be used for the encryption key and that is mapped to the encryption key.

The initialization vector, which is any binary data that is used to initialize a symmetric-key encryption algorithm, is added to moof so that the encryption side and the decryption side may use the same initialization vector.

The list of samples to be encrypted is added to moof so that the decryption side may identify an encrypted sample because whether encryption is performed varies from sample to sample.

The metadata of the original sample includes the number of samples included in the received mdat, a start offset of a first sample, a size of each sample, etc. The broadcast scrambling system 100 internally stores the metadata of the original sample so that each sample may be identified when mdat is received later.

In the broadcast file scrambling method according to an aspect, information that should be changed by encryption corresponding to the encryption application policy among information included in the header box of the input broadcast file includes a size of a sample and a changed size of media data due to the encryption. A broadcast file scrambling method according to another aspect may additionally include storing the metadata of the original sample, the encryption application policy, and the encryption application parameter that are acquired from an input original header box.

The broadcast scrambling system 100 internally stores the metadata of the original sample so that each sample may be identified when mdat is received later and stores the encryption application policy and the encryption application parameter so that sequentially input broadcast file data may be encrypted in the same way.

A broadcast file scrambling method according to still another aspect may additionally include identifying each sample from the media file by using the stored metadata of the original sample when the media data of the broadcast file is input and determining whether each sample of the media data is to be encrypted according to information regarding the list of samples to be encrypted of the stored encryption application parameter.

When mdat is received, the broadcast scrambling system 100 may identify each sample in mdat by using the stored metadata of the original sample.

Also, the broadcast scrambling system 100 may determine whether the identified sample is to be encrypted according to the information regarding the list of samples to be encrypted that is included in the stored encryption application parameter.

A broadcast file scrambling method according to still another aspect may additionally include encrypting the sample to be encrypted on an encryption block basis according to the stored encryption application parameter and include immediately transmitting the encrypted block on a block unit basis.

When the identified sample is determined as a sample to be encrypted, the broadcast scrambling system 100 encrypts the sample according to the stored encryption application parameter. When each sample is encrypted, the broadcast scrambling system 100 performs the encryption by using an encryption key and an initialization vector corresponding to the encryption key identifier by means of an encryption algorithm corresponding to the encryption algorithm identifier written in the encryption application parameter. The broadcast scrambling system 100 encrypts the sample on a block unit basis. As an example, when an AES 128-bit algorithm is used as the encryption algorithm, the sample is encrypted on a 128-bit block unit basis.

Instead of waiting until a corresponding sample is completely encrypted, that is, encrypting and transmitting one sample on a sample basis, the broadcast scrambling system 100 immediately transmits an encrypted block on an encrypted block unit basis. The broadcast scrambling system 100 may immediately perform the transmission while performing the encryption, and thus may transmit a broadcast file with almost no delay.

Also, when the identified sample is not to be encrypted, the broadcast scrambling system 100 immediately transmits the input sample.

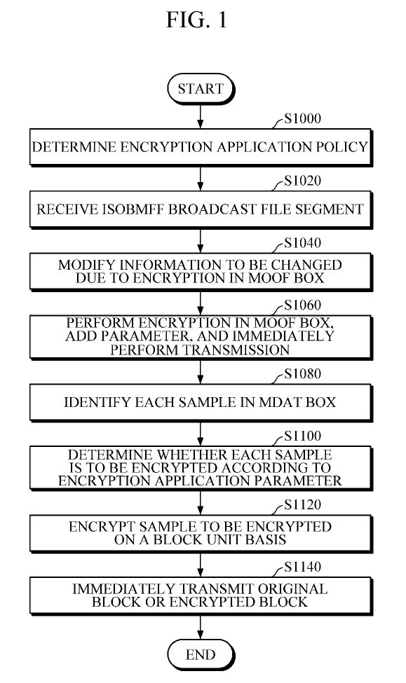

FIG. 1 is a diagram showing a procedure of a broadcast file scrambling method for low latency according to an embodiment.

As shown in FIG. 1, the broadcast file scrambling method for low latency, which is performed by the broadcast scrambling system 100, includes determining an encryption application policy (S1000), receiving an ISOBMFF broadcast file segment through an input interface (S1020), extracting and immediately transmitting information when the received ISOBMFF segment is an initialization segment and modifying information changed in moof due to encryption when the received ISOBMFF segment is a media segment (S1040), immediately transmitting an encryption application parameter by adding the encryption application parameter to moof (S1060), identifying each sample in mdat by using original sample metadata (S1080), determining whether each sample is to be encrypted depending on the encryption application parameter (S1100), encrypting the corresponding sample on a block unit basis when the sample is to be encrypted (S1120), and immediately transmitting an original block or an encrypted block (S1140).

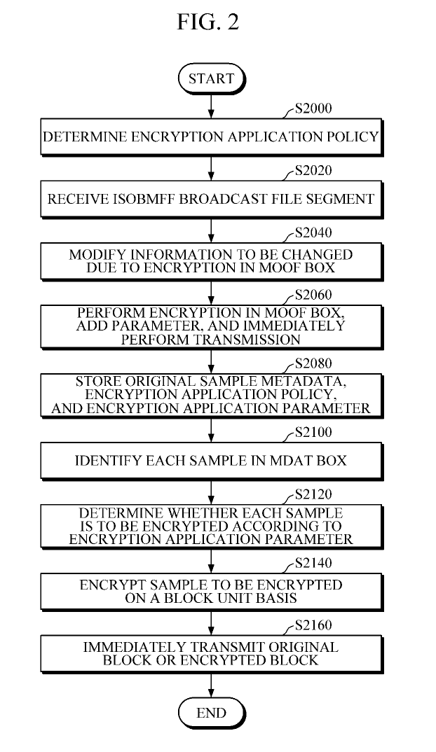

FIG. 2 is a diagram showing a procedure of a broadcast file scrambling method for low latency according to another embodiment.

As shown in FIG. 2, the broadcast file scrambling method for low latency, which is performed by the broadcast scrambling system 100, includes determining an encryption application policy (S2000), receiving an ISOBMFF broadcast file segment through an input interface (S2020), extracting and immediately transmitting information when the received ISOBMFF segment is an initialization segment and modifying information changed in moof due to encryption when the received ISOBMFF segment is a media segment (S2040), immediately transmitting an encryption application parameter by adding the encryption application parameter to moof (S2060), internally storing original sample metadata, the encryption application policy, and the encryption application parameter (S2080), identifying each sample in mdat by using the stored original sample metadata (S2100), determining whether each sample is to be encrypted depending on the encryption application parameter (S2120), encrypting the corresponding sample on a block unit basis when the sample is to be encrypted (S2140), and immediately transmitting an original block or an encrypted block (S2160).

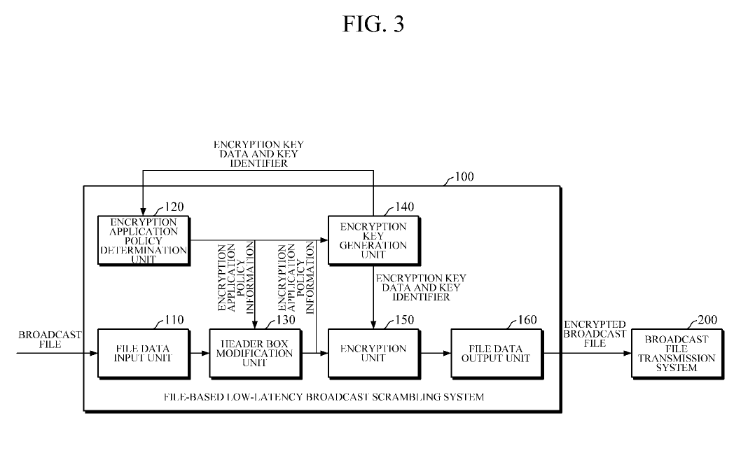

FIG. 3 is a block diagram of a low-latency broadcast scrambling system according to an embodiment. The file-based low-latency broadcast scrambling system 100 according to an embodiment includes a file data input unit 110, an encryption application policy determination unit 120, a header box modification unit 130, an encryption key generation unit 140, an encryption unit 150, and a file data output unit 160.

The broadcast scrambling system 100 may be composed of one or more servers, each including at least one processor, memory, hard disk, and the like.

The file data input unit 110, the encryption application policy determination unit 120, the header box modification unit 130, the encryption key generation unit 140, the encryption unit 150, and the file data output unit 160 of the broadcast scrambling system 100 may each be a set of program instructions executed by a server. However, the present invention is not limited thereto, and the components may be a combination of hardware and the program instruction sets.

The file data input unit 110 receives a broadcast file, which is to be encrypted, and delivers the broadcast file to the header box modification unit 130. In this case, the file data input unit 110 may be connected to an output side of a video/audio encoder providing a file-based output.

The encryption application policy determination unit 120 delivers encryption application policy information of the broadcast file to the header box modification unit 130, the encryption key generation unit 140, and the encryption unit 150. The encryption application policy information is determined before the broadcast file is input into an input interface. The determination of an encryption application policy may be set by an operator through a graphical user interface (GUI) of the broadcast scrambling system 100 or may be set in cooperation with a specific database system. However, the determination of an encryption application policy is not limited to a specific determination and setting procedure or a specific format.

The header box modification unit 130 modifies information that should be changed by encryption corresponding to an encryption application policy among information in a header box included in the broadcast file, adds an encryption application parameter generated according to the encryption application policy to the header box, and immediately delivers the encryption application parameter to the encryption unit 150.

When moof is received through an input interface of the broadcast scrambling system 100, the header box modification unit 130 modifies the size of mdat and the size of each sample present in moof to values changed due to encryption on the basis of an encryption application policy delivered from the encryption application policy determination unit 120. The header box modification unit 130 may pre-calculate the size of mdat and the size of each sample obtained after the encryption on the basis of the size of each original sample discovered through moof and also on the basis of an encryption method found out from the encryption application policy.

The header box modification unit 130 adds the encryption application parameter generated according to the encryption application policy to moof and immediately transmits the encryption application parameter through an output interface even before mdat is received.

The encryption key generation unit 140 generates an encryption key necessary for encryption and delivers the generated encryption key and an encryption key identifier to the encryption unit 150 and the encryption application policy determination unit 120. The encryption key and the encryption key identifier delivered to the encryption application policy determination unit 120 should be pre-generated so that the encryption application policy determination unit 120 may generate encryption application policy information before a broadcast file is input into the input interface.

The encryption key generation unit 140 may periodically change the encryption key according to the encryption application policy information delivered from the encryption application policy determination unit 120.

The encryption unit 150 encrypts an input broadcast file by using the encryption key and the encryption key identifier delivered from the encryption key generation unit 140. The encrypted broadcast file is delivered to the file data output unit 160.

There may be various methods for encrypting the broadcast file. For example, the encryption key may vary for each media track of an ISOBMFF file, and encryption may be performed in units of a sample belonging to a corresponding media track. Alternatively, samples belonging to one media track may be encrypted with the same encryption key or different encryption keys.

The Advanced Encryption Standard (AES) may be used as an encryption algorithm. However, an encryption algorithm used by the broadcast scrambling system 100 is not limited to a specific encryption algorithm for encrypting a track or sample of a broadcast file or to a specific scheme such as a target data range to be encrypted.

The file data output unit 160 may be connected to an input side of a broadcast file transmission system 200, and the encrypted broadcast file is output to the broadcast file transmission system 200.

The encryption application policy of the file-based low-latency broadcast scrambling system 100 according to an embodiment includes an encryption algorithm, an encryption key to be used to encrypt each sample, an encryption key identifier, an initialization vector, a criterion for selecting a sample to be encrypted, and encryption key change period information. Also, the encryption application parameter includes an encryption algorithm identifier, an encryption key identifier, an initialization vector, and a list of samples to be encrypted.

The encryption application policy may include an encryption algorithm, an encryption key, an encryption key identifier, an initialization vector, a criterion for selecting a sample to be encrypted, and encryption key change period information.

The encryption algorithm is an algorithm used to encrypt each sample, and a symmetric-key encryption algorithm with an encryption key and a decryption key the same as each other is used as the encryption algorithm. According to an aspect of the present invention, the 3DES, the AES, and the like may be used.

The encryption key, which is a symmetric key used to encrypt each sample, is also a key that is used during decryption. The encryption key identifier is an identifier for identifying an encryption key used for encryption. The encryption key and the encryption key identifier should be generated by the encryption key generation unit 140 and delivered to the encryption application policy determination unit 120 before the broadcast file is input into the input interface.

The initialization vector is any binary data that is used to initialize the symmetric-key encryption algorithm. The initialization vector is used to encrypt identical plaintext into differing ciphertext whenever the encryption is performed. The encryption algorithm should be initialized by using the same initialization vector at the encryption side and the decryption side.

The criterion for selecting a sample to be encrypted is a criterion that determines whether to encrypt each sample. The broadcast scrambling system 100 may not encrypt all samples but may determine whether to encrypt each sample. Thus, there is a need for a criterion for selecting whether each sample is to be encrypted, and the criterion is included in the encryption application policy.

The encryption key change period information is information regarding a time period in which the encryption key is changed during encryption of a sample in a specific media track. The encryption key may be periodically changed during encryption according to the encryption key change period.

The encryption application parameter includes an encryption algorithm identifier, an encryption key identifier, an initialization vector, and a list of samples to be encrypted. The encryption application parameter is added to moof and used to deliver an encryption scheme of the broadcast scrambling system 100 to a broadcast receiver. The encryption application parameter is generated from the encryption application policy.

The encryption algorithm identifier is an identifier that is used for the encryption and that is mapped to the encryption algorithm, and the encryption key identifier is an identifier that is to be used for the encryption key and that is mapped to the encryption key.

The initialization vector, which is any binary data that is used to initialize a symmetric-key encryption algorithm, is added to moof so that the encryption side and the decryption side may use the same initialization vector.

The list of samples to be encrypted is added to moof so that the decryption side may identify an encrypted sample because whether encryption is performed varies from sample to sample. Accordingly, when the moof is received, the broadcast receiver may determine whether to encrypt each sample in a media track and may know what encryption key and initialization vector are to be used for decryption.

Information that should be changed by encryption corresponding to the encryption application policy among information included in the header box of the broadcast file by the header box modification unit 130 of the file-based low-latency broadcast scrambling system 100 according to an embodiment includes the size of the sample and the changed size of the media data due to the encryption.

The encryption key generation unit 140 of the file-based low-latency broadcast scrambling system 100 according to another embodiment may periodically change the encryption key according to the encryption application policy information delivered from the encryption application policy determination unit 120.

The file-based broadcast scrambling system according to the proposed invention can encrypt and transmit a broadcast file with low latency by calculating a size of a media sample after encryption of the media sample according to a predetermined encryption application policy, modifying a header box, immediately transmitting the modified header box, encrypting the media sample on a block unit basis, and immediately transmitting the media sample.

The present invention has been described above with reference to embodiments referring to the accompanying drawings, but is not limited thereto. Rather, the present invention should be construed as encompassing various modifications that may be apparent to those skilled in the art. The following claims are intended to cover the modifications.

What is claimed is:

1. A broadcast file scrambling method comprising:
determining an encryption application policy before a broadcast file to be encrypted is input;
modifying information to be changed due to encryption corresponding to the encryption application policy among information included in a header box of the input broadcast file; and
adding an encryption application parameter generated according to the encryption application policy to the header box and immediately transmitting the header box.

2. The broadcast file scrambling method of claim 1,
wherein the encryption application policy includes an encryption algorithm, an encryption key to be used to encrypt each sample, an encryption key identifier, an initialization vector, a criterion for selecting a sample to be encrypted, and encryption key change period information,
wherein the encryption application parameter includes an encryption algorithm identifier, an encryption key identifier, an initialization vector, and a list of samples to be encrypted, and
wherein metadata of an original sample includes the number of samples included in media data of a broadcast file to be input, a start offset of a first sample, and a size of each sample.

3. The broadcast file scrambling method of claim 1, wherein information that should be changed by encryption corresponding to the encryption application policy among information included in the header box of the input broadcast file includes a size of a sample and a changed size of media data due to the encryption.

4. The broadcast file scrambling method of claim 2, further comprising storing the metadata of the original sample, which is acquired from an input original header box, the encryption application policy, and the encryption application parameter.

5. The broadcast file scrambling method of claim 2, further comprising:
identifying each sample from the media file by using the metadata of the original sample when the media data of the broadcast file is input; and
determining whether each sample of the media data is to be encrypted according to information regarding the list of samples to be encrypted of the encryption application parameter.

6. The broadcast file scrambling method of claim 5, further comprising:
encrypting the sample to be encrypted on an encryption block basis according to the encryption application parameter; and
immediately transmitting the encrypted block on a block unit basis.

7. A file-based low-latency broadcast scrambling system comprising:
a file data input unit;
an encryption application policy determination unit;
a header box modification unit;
an encryption key generation unit;
an encryption unit; and
a file data output unit,
wherein the file data input unit is configured to receive a broadcast file to be encrypted and deliver the broadcast file to a header box modification unit,
wherein the encryption application policy determination unit is configured to deliver encryption application policy information of the broadcast file to the header box modification unit, the encryption key generation unit, and the encryption unit,
wherein the header box modification unit is configured to modify information that should be change due to encryption corresponding to an encryption application policy among information included in a header box included in the broadcast file, configured to add an encryption application parameter generated according to the encryption application policy to the header box, and configured to immediately deliver the header box to the encryption unit,
wherein the encryption key generation unit is configured to generate an encryption key and deliver the generated encryption key and an encryption key identifier to the encryption unit and the encryption application policy determination unit, and
wherein the encryption unit is configured to encrypt a broadcast file by means of the encryption key and the encryption key identifier, and
wherein the file data output unit is configured to output the encrypted broadcast file.

8. The file-based low-latency broadcast scrambling system of claim 7,
wherein the encryption application policy includes an encryption algorithm, an encryption key to be used to encrypt each sample, an encryption key identifier, an initialization vector, a criterion for selecting a sample to be encrypted, and encryption key change period information, and
wherein the encryption application parameter includes an encryption algorithm identifier, an encryption key identifier, an initialization vector, and a list of samples to be encrypted.

9. The file-based low-latency broadcast scrambling system of claim 7, wherein information that should be changed by encryption corresponding to the encryption application policy among information included in the header box of the broadcast file includes a size of a sample and a changed size of media data due to the encryption.

10. The file-based low-latency broadcast scrambling system of claim 7, wherein the encryption key generation unit periodically changes an encryption key according to the encryption application policy information delivered from the encryption application policy determination unit.
